(19) United States
(12) Patent Application Publication
(10) Pub. No.: US 2026/0230794 A1
(43) Pub. Date: Aug. 6, 2026

(54) EMBEDDED UNIVERSAL INTEGRATED CIRCUIT CARD, CORRESPONDING MANAGING METHOD AND SYSTEM ARCHITECTURE

(71) Applicant: STMicroelectronics International N.V., Geneva (CH)

(72) Inventor: Luigi Di Maggio, Pomigliano D'Arco (IT)

(21) Appl. No.: 19/456,916

(22) Filed: Jan. 22, 2026

(30) Foreign Application Priority Data
Jan. 24, 2025 (IT) 102025000001299

(51) Int. Cl. H04W 8/18

(52) U.S. Cl. CPC H04W 8/183

(57) ABSTRACT

An embedded Universal Integrated Circuit Card (eUICC) for an Internet of Things (IoT) device, configured to enable as active profile a fallback profile in place of a previously-enabled profile upon detection of a loss of connectivity with a communication network of the IoT device, wherein the eUICC comprises a stored application and set of Application Programming Interfaces (APIs) comprising a subset of APIs configured to perform profile managing operation comprising at least operations of enabling (FPD) and disabling (FPA) the fallback profile, the application configured to access the set of APIs of the eUICC, in order to perform the operations (FPD, FPA) of the subset of APIs.

### CROSS-REFERENCE TO RELATED APPLICATIONS

This application claims the benefit of Italian patent application number 102025000001299, filed on January 24, 2025, which application is hereby incorporated herein by reference.

### TECHNICAL FIELD

The description relates to integrated circuit cards.

One or more embodiments can be applied to integrated circuit cards such as, for instance, embedded UICCs, eUICCs.

### BACKGROUND

Integrated circuit cards such as Universal Integrated Circuit Cards, UICCs are widely used in a variety of contexts and applications such as in mobile terminals (mobile network devices) in order to facilitate establishing a connection with the Global System for Mobile Communications, GSM or the Universal Mobile Telecommunications System, UMTS networks, maintaining the integrity and security of personal data.

Embedded UICCs, eUICCs are a type of integrated circuit card based on architectural standards published by the GSM Association, GSMA and configured to facilitate a secure storage of one or more SIM (“Subscriber Identity Module”) card profiles, each of such one or more SIM card profiles comprising unique identifiers and cryptographic keys used by a cellular network service providers in order to uniquely identify each of the profiles.

For instance, such profiles may be used in a mobile network device comprising a corresponding eUICC, thus, enabling such mobile network device to register and securely communicate via the cellular network.

The technical specification of the GSMA SGP.31 and GSMA SGP.32 standard facilitates broadening the use of such eUICCs to IoT (“Internet of Things”) devices, defining requirements and architectures to enable the remote provisioning and management of the eUICC for IoT devices in IoT devices (see, for instance, Specification SGP.31 eSIM IoT Architecture and Requirements Version 1.0 19 April 2022 or Specification SGP.31 eSIM IoT Architecture and Requirements Version 1.2 26 April 2024).

The GSMA SGP.32 technical specification defines the overall architecture of the eUICC IoT system for IoT device (see, for instance, eSIM IoT Technical Specification, Version 1.0.1, 04 July 2023).

IoT devices may be devices comprising sensors, processing ability, software and/or other technologies that can be configured to connect and exchange data with other devices and/or systems over the Internet or other communications networks, for instance, the cellular network.

The general architecture of a system for remotely provisioning and managing an eUICC for IoT devices is illustrated in FIG. 1.

FIG. 1 illustrates an IoT device 100 comprising: an eUICC for IoT devices 102, such eUICC for IoT devices 102 comprising an ISD-R (“Issuer Security Domain – Root”) block 104 and an ISD-P (“Issuer Security Domain – Profile”) block 106 that comprises an MNO-SD (“Mobile Network Operator Security Domain”) block 108; and an IPAd (“IoT Profile Assistant in the IoT Device”) block 110 configured to serve as a proxy between the eUICC for IoT devices 102 and an eSIM IoT remote Manager, eIM 112.

The eUICC for IoT devices 102, in particular, its ISD-R block 104, may be configured to be interfaced with the IPAd block 110 through: a first IPA--eUICC interface ES10a, for performing profile download and installation operations and handling profile discovery, and a second IPA--eUICC interface ES10b, for performing generic eUICC package download and execution.

The IPAd block 110 may be configured to be interfaced with the eIM 112 through an eIM--IPA interface ESipa, for performing profile download and installation operations, which may be used for triggering profile download at the IPAd block 110 and for providing a secure transport of the downloaded profiles to the eUICC for IoT devices 102.

The eIM 112 is a module, usually a software implemented module, for instance, a server, configured to be external to the IoT device 100 and configured to perform remote profile state management operations (PSMOs), that is, subscriptions management operations, and eIM Configuration Operations (eCOs), that is, operations for managing other eIMs, on a single IoT device or a fleet of IoT devices.

The profile state management operations may comprise for instance, sending profile state management packages to the eUICC for IoT devices 102, enable, disable, and delete profiles or to trigger profile downloads at eUICC of the IoT devices. The eIM 112 can either be a stand-alone component or a component of a higher-level functional system (e.g., device management platform).

Such eIM 112 may be configured to manage a single device, for instance, the IoT device 100, or a plurality of IoT devices, facilitating the management of such devices and their profiles.

To manage a given device, such eIM 112 may be configured to be interfaced with the eUICC for IoT devices 102 of such given device through an eIM--eUICC interface ESep, such eIM--eUICC interface ESep being a logical end-to-end interface between eIM 112 and such eUICC for IoT devices 102 used to transfer eUICC packages for profile state management and eIM configuration data sent by the eIM 112. This eIM--eUICC interface ESep may be implemented through a communication network, e.g., a mobile or cellular communication network such as GSM, 3G such as UMTS or WCDMA, 4G such as LTE, 5G networks. The communication architecture in general comprises at least a communication network which allows communication, i.e., exchange of signals and data, with the IoT device 100 by remote servers and communication entities, For simplicity’ sake is not shown explicitly in FIG. 1.

The eUICC packages for profile state management may comprise a REMOTE administration command or a plurality of REMOTE administration commands, which can be divided into two groups, a first group comprising commands related to eIM Configuration Operations (eCOs) and a second group comprising commands related to Profile State Management Operations (PSMOs).

Such REMOTE administration commands may comprise, for instance, the following types of commands: an enable command, used to enable an installed profile in the eUICC 102, related to Profile State Management Operations; a disable command, used to disable an enabled profile in the eUICC 102, related to Profile State Management Operations; a delete command, used to delete an installed profile in the eUICC 102, related to Profile State Management Operations; a list of profile information command (related to Profile State Management Operations), used by the eIM 112 to retrieve a list of profile information for installed profiles, including their current state, that is, enabled or disabled, and their associated profile metadata; a get RAT ("Rules Authorization Table”) command, used by the eIM 112 to retrieve the Rules Authorization Table, RAT from the eUICC 102; a configure auto-enable command, used to configure an automatic enabling of a profile in the eUICC 102, related to Profile State Management Operations.

It comprises also eIM Configuration operations (eCO) such as ADD eIM command, to add an associated eIM 112 to the eUICC 102 by providing eIM configuration data, an update eIM command, used to update eIM configuration data within the eUICC 102, a DELETE eIM command, used to delete an associated eIM 112 from the eUICC 102; and/or a list eIM command, used by the eIM 112 to request the eUICC 102 to provide a list of currently configured associated eIMs. Therefore, the eIM 112 may be further configured to manage a list of eIMs on an eUICC, that is, to perform eCO.

Such eIM 112 is further configured to communicate with: a SM-DP+ (“Subscription Manager Data Preparation +”) block 114, which is a server configured to prepare, store, and deliver digital eSIM profiles based on information obtained from an operator 116, e.g., a MNO (Mobile Network Operator), through an operator--SM-DP+ interface ES2+, such operator--SM-DP+ interface ES2+ being used by the operator to request the preparation of a profile for one or more eUICCs for IoT devices 102 and for other administrative functions, and a SM-DS (“Subscription Manager Discovery Server”) block 118, which is a server configured to hold a list of the profiles that are available to each of the considered devices.

The communication between the eIM 112 and the SM-DP+ block 114 may be implemented through an eIM--SM-DP+ interface ES9+’, used for profile download and installation and being secured with an HTTPS (“HyperText Transfer Protocol Secure”) protocol in server authentication mode.

The communication between the eIM 112 and the SM-DS block 118 may be implemented through an eIM--SM-DS interface ES11’, used to retrieve records of the events between such eIM 112 and such SM-DS block 118 and being secured by TLS (“Transport Layer Security”) in server authentication mode.

In addition, such SM-DP+ block 114 may be configured to be interfaced with the SM-DS block 118 through an SM-DS--SM-SP+ interface ES12, used by the SM-DP+ block 114 to manage event registrations and event deletions on the SM-DS block 118.

The MNO-SD block 108 may be configured to be interfaced with the operator 116 through an operator--eUICC interface ES6, used by the operator in order to manage their profiles stored within the eUICC for IoT devices 102 via OTA (“Over-The-Air”) services.

The IPAd block 110 may be further configured to be interfaced with the SM-DP+ block 114 through an IPA--SM-DP+ interface ES9+, used for providing a secure transport of profile packages between the SM-DP+ block 114 and the IPAd block 110, for instance, using an HTTPS (“HyperText Transfer Protocol Secure”) protocol in server authentication mode to communicate.

In addition, such IPAd block 110 may be further configured to be interfaced with the SM-DS block 118 through an IPA--SM-DS interface ES11, used to retrieve records of events between such IPAd block 110 and such SM-DS block 118 and being secured by TLS (“Transport Layer Security”) in server authentication mode.

The eUICC for IoT devices 102 may be further configured to be interfaced with the SM-DP+ block 114 through an SM-DP+--eUICC interface ES8+ configured to couple the ISD-P block 106 of the eUICC for IoT devices 102 with the SM-DP+ block 114 to provide a secure end-to-end channel between them for the administration of such ISD-P block 106 and the associated profiles during download and installation operations.

Such coupling provided by such SM-DP+--eUICC interface ES8+ may be intended to be tunneled either over the IPA--SM-DP+ interface ES9+ and the second IPA--eUICC interface ES10b for a direct profile download, in which the IPAd block 110 can directly communicate with the SM-DP+ block 114, or the eIM--SM-DP+ interface ES9+’, the eIM--IPA interface ESipa, and the second IPA--eUICC interface ES10b for an indirect profile download, in which the IPAd block 110 communicates with the SM-DP+ block 114 via the eIM 112.

In the general architecture of the system for remotely provisioning and managing eUICCs for IoT devices 102 as described in FIG. 1, such eUICC for IoT devices 102 is to be associated with at least one eIM 112 before being able to do any profile state management operations, i.e., an eIM whose eIM Configuration Data is available within the eUICC and used by the eUICC for verification of an eIM configuration operation or PSMO is in a specific relationship with an eUICC. Such Configuration Data are used by the eUICC for verification of an eIM Configuration Operation or PSMO, as for instance defined in the Specification SGP.31 eSIM IoT Architecture and Requirements Version 1.0 19 April 2022.

eIMs 112 are configured to perform at least the following operations: associate other eIMs to a eUICC, for instance, via the ADD eIM command; delete other eIMs from a eUICC, that is, removing the association between the eIM that is to be deleted and the eUICC, for instance, via the DELETE eIM command; and enable, disable, and delete installed profiles in the eUICC.

It is underlined that, with respect to the architecture shown in FIG. 1, a system for remotely provisioning and managing an eUICC for IoT devices may have also an IoT Profile Assistant in the eUICC IPAe, IoT Profile Assistant in the eUICC, (this being also described in the GSMA SGP.32 specification) instead of an IoT Profile Assistant in the IoT Device IPAd, 110 in FIG. 1.

The ISD-R block 104 comprised in the eUICC for IoT devices 102 may be configured to be interfaced with the eIM 112 via the IPAe, for instance, also here through the eIM--IPA interface ESipa used to perform profile download and installation operations and the eIM--eUICC interface ESep, triggering profile download at the IPAe and providing a secure transport of the downloaded profiles to the eUICC for IoT devices 102. Also the IPAe may be further interfaced with the SM-DP+ block 114 through the IPA--SM-DP+ interface ES9+, providing a secure transport of profile packages between the SM-DP+ block 114 and the IPAe, for instance, using an HTTPS (“HyperText Transfer Protocol Secure”) protocol in server authentication mode to communicate. In addition, such IPAe may be interfaced with the SM-DS block 118 through the IPA--SM-DS interface ES11, to retrieve records of events between such IPAe and such SM-DS block.

It is noted that same conclusions related to an association performed via the IPAd block 110 described above are also valid for associations performed via the IPAe, thus, for instance, an ADD Initial eIM command sent by the IPAe to the eUICC for IoT devices 102 does not comprise a signature.

In this context, from version v1.1 of the GSMA specification SGP.32 it has been introduced a new type of profile, indicated as the Fallback Profile.

The Fallback profile is a profile the IPA, such as IPAd 110, can enable without eIM involvement, if it detects the current profile has no connectivity, e.g., loss of network.

Loss of network can be associated to different criteria/triggers condition ( e.g., direct modem driven commands, Network Rejection event, Location Status event, Provide Local information event). It is implementation-specific as to which of the above criteria is used to determine network failure in an eUICC.

The property of Fallback can be assigned to a profile already loaded by means of command signed by the eIM. This is described for instance under paragraph 3.4.6 of such specification, indicating a procedure that defines the execution of a setFallbackAttribute command contained within an eUICC Package (as defined in 3.3.1 Generic eUICC Package Download and Execution). The command is used to set the Fallback Attribute for the target Profile. The Fallback Attribute is an attribute of a Profile which, when set, identifies the Profile to be enabled by the Fallback Mechanism. The Fallback Mechanism is an eUICC-based mechanism which enables and disables the Profile with Fallback Attribute set.

More in detail, with reference to FIG. 2 which shows a signal diagram illustrating signals exchange between an IPA, e.g., a IPAd 110, a currently enabled profile P_{E}, i.e., the profile which is currently used, i.e., the active profile, and a Fallback Profile P_{FB}, the IPAd 110, after detection of a loss of connectivity LoC, performs an action IPE of enabling the Fallback Profile P_{FB}, which causes the active profile to move APT from the currently enabled profile P_{E} to the fallback profile P_{FB}. This enabling IPE may be performed according to the Fallback Mechanism, as described under 5.9.20 in v1.1 of the SGP.32. The Function Provider is embodied by the ISD-R 104. The IPAd 110 calls the function performed by the ISD-R 104 as Function Provider. This function for the eUICC may be used by the IPAd 110 to instruct the eUICC to enable the Fallback Profile and to disable the currently Enabled Profile. Upon reception of this function, the ISD-R verifies that there is an enabled Profile. If not, the procedure stops and the result of this command indicates an error; verifies that the fallbackAttribute is set for a Profile on the eUICC. If not, the procedure stops and the result of this command indicates an error; verifies that an Emergency Profile - as per SGP .31 a Profile which complies with regulatory requirements and only provides the capability to make Emergency Calls and receive calls from an Emergency center ( e.g., Public Safety Answering Point)- is disabled. If it is enabled, the procedure stops and the result of this command indicates error; verify that the Fallback Profile is disabled. If not, the procedure stops and the result of this command indicates an error.

The IPAd 110 also is configured to perform subsequently an action IPD of disabling such Fallback Profile P_{FB}, e.g., when another profile needs to be enabled, e.g., when the loss of connectivity LoC is over. This is performed using for instance using the ReturnFromFallback function, via SGP.32, again called by the IPAd 110 to the ISD-R 104. Upon reception of this function, the ISD-R checks if the currently enabled Profile is the Fallback Profile. If not, the procedure stops, and the result of this command indicates an error.

Reference can be also made to FIG. 18 from version v1.1 of the GSMA specification SGP.32, where a signal diagram representing a more detailed implementation of the eUICC IPA service (ISD-R) operation in enabling or disabling the Fallback profile is described.

However, currently the owner of the profile that is offering connectivity, e.g., the MNO, such as operator 116 in FIG. 1, cannot manage Fallback profile in an IoT device according its own heuristic or needs, outside the above described mechanism.

### SUMMARY

An object of one or more embodiments is to contribute in providing solutions that facilitate to manage the Fallback profile in particular by the MNO or operator.

According to one or more embodiments, that object is achieved via an embedded Universal Integrated Circuit Card having the features set forth in the claims that follow.

One or more embodiments concern a related method for managing an embedded Universal Integrated Circuit Card.

One or more embodiments concern a related system architecture.

The claims are an integral part of the technical teaching provided in respect of the embodiments.

Solutions as described herein include an embedded Universal Integrated Circuit Card, eUICC, for Internet of Things, IoT, devices, configured to enable as active profile a Fallback profile in place of a previously enabled profile upon detection of a loss of connectivity with a communication network of the IoT device, wherein the eUICC comprises stored an application and a set of Application Programming Interfaces comprising a subset of Application Programming Interfaces configured to perform profile managing operation comprising at least operations of enabling and disabling the Fallback profile, the application being configured to access the set of Application Programming Interfaces of the eUICC, in order to perform the operations of subset of Application Programming Interfaces.

In various embodiments, the set of Application Programming Interfaces comprises at least a first Application Programming Interface configured to enable the fallback, a second Application Programming Interface configured to disable the Fallback profile, a third Application Programming Interface configured to check if a profile currently enabled for operation corresponds to the Fallback profile.

In various embodiments, the application is configure to check by the third Application Programming Interface the currently enabled profile and take an action to disable the Fallback profile by the second Application Programming Interface configured to disable the Fallback profile coming back to a previously enabled profile or enable the Fallback Profile by the first Application Programming Interface configured to enable the fallback depending on the current enabled profile corresponding to the Fallback profile or a previously enabled profile.

In various embodiments, the application is configured to, following an enabling of the fallback profile by a remote manager module, in particular an IoT Profile Assistant in the IoT Device or an IoT Profile Assistant in the eUICC, upon detection of a loss of connectivity which determines a profile switch from the enabled profile to the fallback profile, then check that the current enabled profile corresponds to the Fallback profile, and switching back from the Fallback profile, enabling the previously enabled profile and disabling by the second Application Programming Interface the Fallback profile.

In various embodiments, the application is configured to, upon detection of a loss of connectivity by the application, enable, through the first Application Programming Interface configured to enable the fallback, the Fallback profile.

In various embodiments, the application is configured to ignore action to enable and/or disable the Fallback Profile by the remote manager module, in particular an IoT Profile Assistant in the IoT Device or an IoT Profile Assistant in the eUICC.

In various embodiments, the subset of Application Programming Interfaces is configured to operate through native modules in the operating system of the eUICC that manage profiles installed on the eUICC.

In embodiments the solution here described refers also to a method for managing an embedded Universal Integrated Circuit Card, eUICC, for Internet of Things, IoT, devices comprising an operation of enabling a Fallback profile in place of a previously enabled profile upon detection of a loss of connectivity with a communication network of the IoT device, the method comprising managing at least operations of enabling and disabling of the Fallback profile by an application stored in the eUICC which is configured to access a set of Application Programming Interfaces of the eUICC, comprising a subset of Application Programming Interfaces configured to perform profile managing operation comprising at least operations of enabling and disabling the Fallback profile.

In various embodiments, the set of Application Programming Interfaces comprises at least a first Application Programming Interface configured to enable the fallback, a second Application Programming Interface configured to disable the Fallback profile, a third Application Programming Interface configured to check if a profile currently enabled for operation corresponds to the Fallback profile.

In various embodiments, the method comprises checking by the third Application Programming Interface the currently enabled profile and take an action to disable the Fallback profile by the second Application Programming Interface configured to disable the Fallback profile coming back to a previously enabled profile or enable the Fallback Profile by the first Application Programming Interface configured to enable the fallback depending on the current enabled profile corresponding to the Fallback profile or a previously enabled profile.

In various embodiments, the method comprises, following an enabling of the fallback profile by a remote manager module, in particular an IoT Profile Assistant in the IoT Device or an IoT Profile Assistant in the eUICC, upon detection of a loss of connectivity which determines a profile switch from the enabled profile to the fallback profile, then checking by the application that the current enabled profile corresponds to the Fallback profile, and switching back from the Fallback profile, enabling the previously enabled profile and disabling by the second Application Programming Interface the Fallback profile.

In various embodiments, upon detection of a loss of connectivity by the application, enabling by the application, through the first Application Programming Interface configured to enable the fallback, the Fallback profile.

In various embodiments, the method comprises ignoring action to enable and/or disable the Fallback Profile by the remote manager module, in particular an IoT Profile Assistant in the IoT Device or an IoT Profile Assistant in the eUICC.

In various embodiments, the embedded Universal Integrated Circuit Card, eUICC, for Internet of Things, IoT, devices is operated according to the GSMA SGP.32 standard.

In embodiments the solution here described refers also to a system architecture, comprising: an embedded Universal Integrated Circuit Card, eUICC, for Internet of Things, IoT, devices operating in an IoT device according to embodiments.

Therefore, solutions as described herein facilitate the management of the fallback profile in a eUICC for IoT devices in case of loss of connectivity without facing the problem that the owner of the profile that is offering connectivity, cannot manage Fallback profile according its own heuristic or needs.

### BRIEF DESCRIPTION OF THE DRAWINGS

One or more embodiments will now be described, by way of example only, with reference to the annexed figures, wherein:

FIG. 1, as previously described, illustrates schematically a general architecture of a system for remotely provisioning and managing an eUICC for IoT devices;

FIG. 2, as previously described, is a signal diagram illustrating signals exchange between modules of such architecture of a system for remotely provisioning and managing an eUICC for IoT devices;

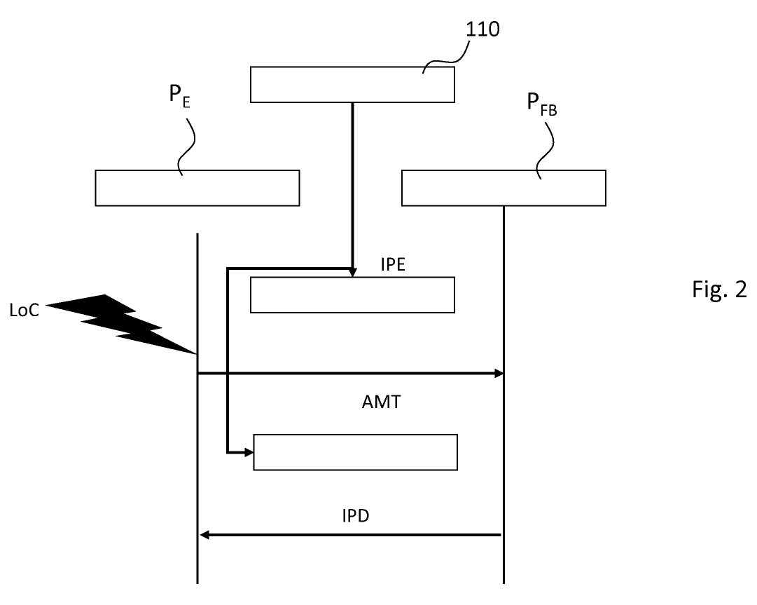

FIG. 3 illustrates schematically an operation of the method according to embodiments of the present description;

FIG. 4 illustrates an exemplary communication diagram in a first scenario of operation according to embodiments of the present description;

FIG. 5 illustrates an exemplary communication diagram in a second scenario of operation according to embodiments of the present description; and

FIG. 6 shows schematically modules implementing the method according to embodiments of the present description

Corresponding numerals and symbols in the different figures generally refer to corresponding parts unless otherwise indicated.

The figures are drawn to clearly illustrate the relevant aspects of the embodiments and are not necessarily drawn to scale.

The edges of features drawn in the figures do not necessarily indicate the termination of the extent of the feature.

### DETAILED DESCRIPTION OF ILLUSTRATIVE EMBODIMENTS

In the ensuing description one or more specific details are illustrated, aimed at providing an in-depth understanding of examples of embodiments of this description. The embodiments may be obtained without one or more of the specific details, or with other methods, components, materials, etc. In other cases, known structures, materials, or operations are not illustrated or described in detail so that certain aspects of embodiments will not be obscured.

Reference to “an embodiment” or “one embodiment” in the framework of the present description is intended to indicate that a particular configuration, structure, or characteristic described in relation to the embodiment is comprised in at least one embodiment. Hence, phrases such as “in an embodiment” or “in one embodiment” that may be present in one or more points of the present description do not necessarily refer to one and the same embodiment.

Moreover, particular configurations, structures, or characteristics may be combined in any adequate way in one or more embodiments.

The headings/references used herein are provided merely for convenience and hence do not define the extent of protection or the scope of the embodiments.

For simplicity and ease of explanation, throughout this description, and unless the context indicates otherwise, like parts or elements are indicated in the various figures with like reference signs, and a corresponding description will not be repeated for each and every figure.

Solutions as disclosed here facilitate the owner of the profile that is offering connectivity, e.g., the MNO, to manage the Fallback profile, as for instance defined in GSMA SGP .32, according its own heuristic or needs.

Therefore, solutions as described herein are configured to provide a proprietary mechanism that allows a Java application, e.g., belonging to the MNO, to manage a Fallback profile via API (Application Programming Interface) offered by the operating system according to a need or heuristic decided by the subject having access to the application, e.g., the MNO itself. Regardless of the IPAd or IPAe behavior, an application is thus able to check the current enabled profile ad take an action to come back to previous enabled profile or enable Fallback before the IPAd or IPAe does.

Solutions according to the present description disclose an embedded Universal Integrated Circuit Card, eUICC, for Internet of Things, IoT, devices, which substantially, besides being configured to enable, according to the GSMA SGP.32, as active profile a Fallback profile in place of a previously enabled profile upon detection of a loss of connectivity with a communication network of the IoT device, also is configured with a proprietary mechanism to manage the fallback profile, in particular stores an application or applet and set of enhanced APIs, comprising a subset of APIs configured to perform profile managing operation comprising at least operations of enabling and disabling the Fallback profile, the application or applet accessing the set of enhanced APIS of the eUICC to perform the operations of such subset of APIS. The subset includes at least a first, second and third API, to enable the fallback profile, disable the fallback profile and to check which profile is currently active, respectively.

Solutions according to the present description disclose also a correspond method for managing an embedded Universal Integrated Circuit Card, eUICC, for Internet of Things, IoT, devices.

It is noted that the embedded Universal Integrated Circuit Card, eUICC, for Internet of Things, IoT, devices 102 may be operated according to the GSMA SGP.32 standard or the GSMA SGP.31 standard.

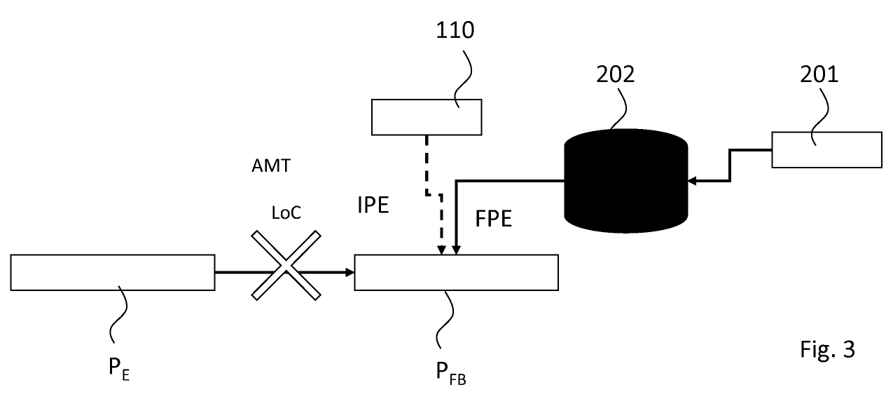

FIG. 3 shows schematically blocks in the IoT device 100 implementing operations of the method here described. As it can be seen, an application 201, e.g., an applet, is stored in the eUICC 102. Such application 201 is configured to access a set of APIs, or Application Programming Interfaces, 202 of such eUICC, 102, in particular of the Operating System of such eUICC 102.

Thus, when, following the occurring of a Loss of Connectivity Loc and its detection by the device 100, an operation of switch AMT from the enabled profile P_{E} to the Fallback profile P_{FB} is commanded, by an enable command IPE, by the IPA 110, the application 201, for instance a Java applet, which is stored in the system, i.e., the eUICC 102, accesses the operating system API 202 to perform FPE an enabling of the fallback profile P_{FB}. Thus, according to the solution here described, a proprietary mechanism allows the Java application or applet 201, which for instance belongs to the MNO, e.g., user 116, to manage, e.g., enable FPE, the Fallback profile P_{FB} via API 202 offered by the operating system 201 according to the MNO needs. Regardless of the IPA behavior, e.g., the ability to perform action IPE, in particular according to the rule of Fallback Mechanism as per, e.g., SGP .32, the application 201 is able to check the currently enabled profile, i.e., which profile is currently active, ad take an action either to come back to the previously enabled profile P_{E}, i.e., the profile which was active before the Loss of Connectivity LoC event, or enable the Fallback Profile P_{FB}, in particular before the IPA 110 does.

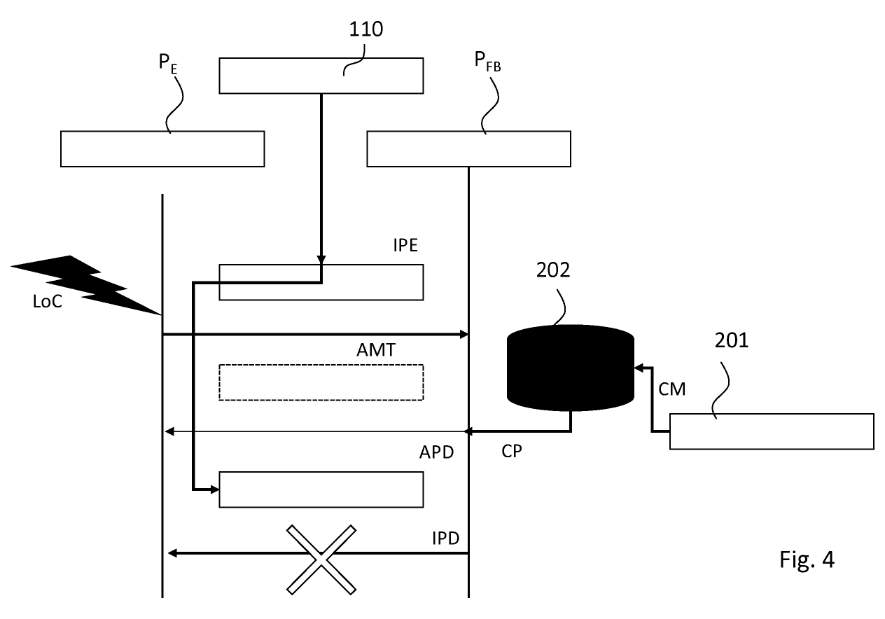

In FIG. 4 it is shown a signal diagram pertaining an exemplary scenario in which the IPA 110 detects a loss of connectivity and enables the Fallback profile P_{FB}. The application 201 subsequently checks CP the currently enabled profile and disables APD the Fallback profile P_{FB}, turning back to the originally enabled profile, e.g., the MNO profile which was active before the Loss of Connectivity LoC.

Thus, in more detail as shown in FIG. 4, then, upon a loss of connectivity Loc detection, the IPA 110 performs IPE an enabling of the Fallback profile P_{FB}. This determines a profile switch AMT, i.e., a switch of the profile which is active, from the enabled profile P_{E} to the Fallback profile P_{FB}. The application 201 then accesses CM the API 202 to perform a check CP of the currently enabled profile, i.e., the currently active profile, and then performs a switch back AMB to the enabled profile P_{E}. The operation IPD of disable Fallback profile by IPA is ignored.

As mentioned, the switch AMT can be performed by the Fallback mechanism, as described for instance in SGP 32 5.9.20, with reference to the ExecuteFallbackMechanism provided by the ISD-R 104 and called by the IPA 110 to instruct the eUICC 102 to enable the Fallback Profile and to disable the currently Enabled Profile. As indicated previously, this function is performed in an atomic way, meaning that in case of any error during the function execution, the command stops and leave the involved Profiles in their original states (prior to function execution).

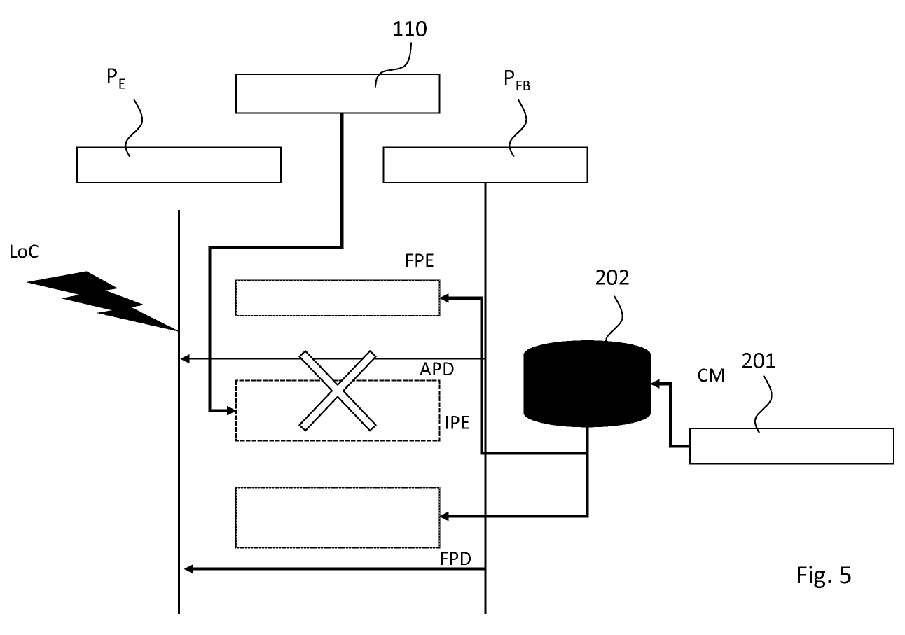

In FIG. 5 it is shown a signal diagram pertaining another exemplary scenario in which the application 201 detects a loss of connectivity LoC, in particular before the IPA 110, and enables FPE, through the operating system API 202, the Fallback profile P_{FB}. The action IPE of enable fallback Profile by the IPA 110 is ignored.

More in detail, the application 201, upon detection of a Loss of Connectivity LoC, first performs CP, a check of the active profile, then, if it detects that the enabled profile P_{E} is the active profiles, enables FPE the Fallback profile, through a corresponding first API which is provided in the set of APIs 202 (e.g., EnableFallbackProfile() as detailed below).

The action IPE of enable fallback Profile by the IPA 110 is ignored.

Then, when deemed necessary, e.g., when Loss of Connectivity LoC is over, the application 201 is configured to perform a disable of the Fallback profile via a corresponding second API provided in set of API 202 (e.g., DisableFallbackProfile() as detailed below).

Also the check CP is performed by a third API which is provided in the set of APIs 202 (e.g., IsCurrentProfileFallback() as detailed below).

The proposed solution is thus a proprietary mechanism, i.e., it is implemented by further modules, namely software modules, which cooperates with the existing software and hardware operating according to a standard, for instance GSMA SGP.32.

Thus, the solution may provide an interface implemented with methods to allow an application 201 to manage the Fallback profile P_{FB}.

According to the solution, to the set of API of the operating system of the card 102 the following API may be added to obtain the set of API 202: a first API, for instance EnableFallbackProfile(), which enables the profile with the Fallback Attribute (if any), i.e., the Fallback profile P_{FB}, a second API, for instance DisableFallbackProfile(), disables the profile with the Fallback Attribute, ), i.e., the Fallback profile P_{FB}, a third API, for instance IsCurrentProfileFallback(), checks in the current enabled profile is the Fallback profile P_{FB},

These APIs are preferably defined in Java for visibility reason and implemented in native C code, so that they can access to operating system module, i.e., native modules written in C code, that manage profiles installed on card, in order to allow the calling application to enable/disable Fallback profile according the requirements of the customer.

These APIs in particularly operate by interacting with the ISD-R 104, which like for the Fallback Mechanism, is the Function Provider, while the caller of the Function is in this case the application 201, instead of the IPA 100.

Thus the application 201 can disable or enable the Fallback profile without requiring the IPA. This can be exploited in different manners. Regarding the disabling of the Fallback profile, for instance a command can be received by the MNO 106, to disable the Fallback profile, like described with regard to FIG. 5. Also the application 201 may be configured, in response to the occurring of a condition or in response to the expiry of a given time counted by a timer or based on location status information, to disable the profile. The Fallback profile in any case offers temporary connectivity so that both solutions are applicable. Regarding the enabling operation like the one described with reference to FIG. 4 can be managed by the application 201 which may be configured, in response to the occurring of a condition or in response to the expiry of a given time counted by a timer or based on location status information, to enable the profile.

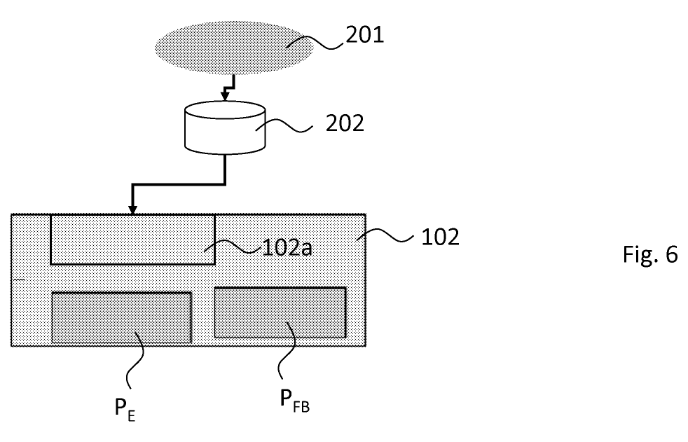

In FIG. 6 it is shown a schematic diagram of the block pertaining the method here described.

The application or applet 201 accesses the set of API 202, which is a set of API enhanced with the first, second and third API as indicated above, which in turn accesses a profile manager module or modules 102a within the card, in particular eUICC, 102.

The profile manager modules 102 are configured to manage then the enabled profile P_{E} and the Fallback profile P_{FB} on the basis of the methods indicated by the first, second and third API. The profile manager module 102a is in general an operating system module configured to perform Profile Management Operations, which may comprise one or more of Profile Downloading, Profile deletion, Profile enabling, and Profile disabling.

Such modules 102a are the same modules, written in C module, which are accessed by the ISD-R 104 to enable or disable profile, and are accessed by the first, second and third API. Thus, substantially the first API may implement the same operations of the Enable Profile procedure (SGP .22, 3.2.1) accessing directly the native modules of the operating system. Similarly, the second API may implement the same operations of the Disable procedure (SGP .22, 3.2.2). In the case of the solution here described the application 201 is configured to call such first, second and third APIs (which were imported, i.e., introduced, in the set of APIs 202, as JAVA API package in particular, by application 201, based on an internally generated command ( e.g., by a timer, or by a location status information or by the detection of another information or occurring of condition) or externally ( e.g., a command sent by the MNO 106) which enhance the set of API 202, such APIs accessing directly the profile management modules 102a, i.e., the same native modules of the operating system of the card accessed by the Enable Profile and Disable profile procedures described in the specification SGP.22, performing for instance the same sequence of action. In embodiments, the first, second and third API here described can implement the operation of the functions ExecuteFallbackMechanism and ReturnfromFallBack functions from SGP.32.

In other words, the first, second and third API, once called, they “jump” to the native modules of the operating system, i.e., the profile manager modules 102a, that manage the enabling/disabling of profiles performing the relevant action.

The first, second and third API, e.g., EnableFallbackProfile(),DisableFallbackProfile(),IsCurrentProfileFallback() also always perform checks internally before doing any action, according to the operation that takes place.

Thus, on the basis of the description above, the solution described through the above embodiments is directed to an embedded Universal Integrated Circuit Card, eUICC, e.g., 102 for Internet of Things, IoT, devices, e.g., 100, configured to enable, e.g., by the IPA 110 or 110’, as active profile a Fallback profile, e.g., P_{FB} in place of a previously enabled profile, e.g., P_{E} which was active, upon detection of a loss of connectivity, e.g., LoC with a communication network of the IoT device, 100, wherein such eUICC, e.g., 102, comprises stored an application, e.g., 201, which may be an applet, in particular a Java applet, and a set of Application Programming Interfaces, e.g., 202, comprising a subset of Application Programming Interfaces configured to perform profile managing operation comprising at least operations of enabling, e.g., FPD, and disabling, e.g., FPA, the Fallback profile (P_{FB}), e.g., the card set of APIs enhanced with at least enabling and disabling APIs, the application, e.g., 201 being configured to access the set of Application Programming Interfaces, e.g., 202, of the eUICC, 102, in order to perform the operations, e.g., disabling and/or enabling FPD, FPA, of the subset of Application Programming Interfaces.

The application 201 is in particular additional with respect to the remote managing module, e.g., IPad or IPae 110, which in particular operates through the ISD-R 104. The application 201 accesses the set of Application Programming Interfaces, e.g., 202, comprising a subset of Application Programming Interfaces configured to perform profile managing operation, in particular by accessing directly the corresponding native modules of the operating system.

In particular, the set of Application Programming Interfaces, e.g., 202, comprises at least a first Application Programming Interface, corresponding for instance to EnableFallbackProfile(), configured to enable the fallback profile, e.g., P_{FB}, a second Application Programming Interface, corresponding for instance to DisableFallbackProfile(), configured to disable the Fallback profile, e.g., P_{FB}, a third Application Programming Interface corresponding for instance to IsCurrentProfileFallback() configured to check if a profile currently enabled for operation corresponds to the Fallback profile, e.g., P_{FB}.

The application, e.g., applet 201, may be configured to check, e.g., CP by the third Application Programming Interface, e.g., IsCurrentProfileFallback() the currently enabled profile and take an action to disable the Fallback profile, e.g., P_{FB} by the second Application Programming Interface, e.g., DisableFallbackProfile() configured to disable the Fallback profile, e.g., P_{FB}, coming back to a previously enabled profile, e.g., P_{E}, or enable the Fallback Profile, e.g., P_{FB}, by the first Application Programming Interface, e.g., EnableFallbackProfile(), configured to enable the fallback, e.g., P_{FB}, depending on the current enabled profile corresponding to the Fallback profile, e.g., P_{FB}, or a previously enabled profile, e.g., P_{E}.

In different scenarios the application 201 may configured to: following an enabling, e.g., operation IPE, of the fallback profile, e.g., P_{FB}, by a remote manager module, e.g., 112, in particular the IoT Profile Assistant in the IoT Device 110 or the IoT Profile Assistant in the eUICC 110’, upon detection of a loss of connectivity, LoC, which determines a profile switch, e.g., AMT, from the enabled profile, e.g., P_{E}, to the fallback profile, e.g., P_{FB}, then check, e.g., CP by the third API in the subset, that the current enabled profile corresponds to the Fallback profile, e.g., P_{FB}, and switching back, e.g., AMB, from the Fallback profile, e.g., P_{FB}, enabling the previously enabled profile, P_{E}, i.e., the profile active when the loss of connectivity occurred, and disabling by the second Application Programming Interface, e.g., DisableFallbackProfile(), the Fallback profile, e.g., P_{FB}; upon detection of a loss of connectivity, e.g., LoC, enable, through the first Application Programming Interface, e.g., EnableFallbackProfile(), configured to enable the Fallback profile, the Fallback profile, e.g., P_{FB}.

Also, as indicated, the subset of Application Programming Interfaces, e.g., the three APIS added to the set 202, is configured to operate through native modules in the operating system of the eUICC, e.g., 100 that manage profiles installed on the eUICC 100, e.g., the operating system native modules which performs the enabling, disabling and checking of which profile is currently enabled, for instance following the operations of the enabling/disabling procedures or function is SGP.22/SGP.32 as described above.

The solution refers also to a corresponding method for managing embedded Universal Integrated Circuit Card, eUICC, e.g., 102 for Internet of Things, IoT, devices, e.g., 100, comprising an operation of enabling a Fallback profile, e.g., P_{FB} in place of a previously enabled profile, e.g., P_{E}, upon detection of a loss of connectivity, e.g., LoC, with a communication network of the IoT device, e.g., 100, the method comprising managing at least operations of enabling and disabling of the Fallback profile, e.g., P_{FB}, by an application, e.g., 201, stored in the eUICC, e.g., 102, which is configured to access a set of Application Programming Interfaces, e.g., 202, of the eUICC, e.g., 102, comprising a subset of Application Programming Interfaces configured to perform profile managing operation comprising at least operations of enabling, e.g., FPD, and disabling, e.g., FPA, the Fallback profile, e.g., P_{FB}.

Such method then performs also the other operations which the eUICC is configured to perform as described above.

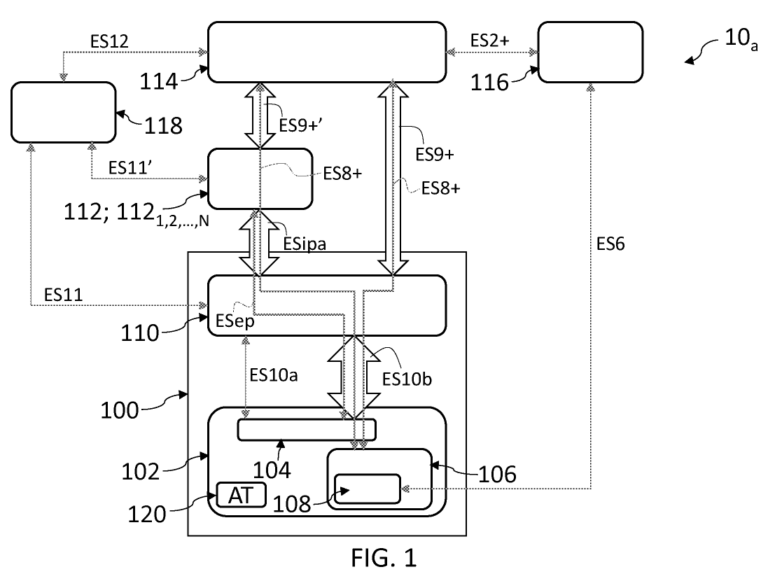

Thus, solutions as described herein facilitate the management of the fallback profile in a eUICC for IoT devices in case of loss of connectivity without facing the problem that the owner of the profile that is offering connectivity, e.g., the MNO, e.g., operator 116 in FIG. 1, cannot manage Fallback profile according its own heuristic or needs.

Without prejudice to the underlying principles, the details and the embodiments may vary, even significantly, with respect to what has been described by way of example only without departing from the scope of the embodiments.

The extent of protection is determined by the annexed claims.

What is claimed is:

1. An embedded Universal Integrated Circuit Card (eUICC) for an Internet of Things (IoT) device, the eUICC comprising:
a stored set of application programming interfaces (APIs) comprising a subset of APIs configured to perform profile managing operations comprising at least an enabling a fallback profile operation and a disabling the fallback profile operation; and
a stored application configured to access the stored set of APIs of the eUICC, in order to perform the enabling and disabling the fallback profile operations of the subset of APIs;
wherein the eUICC is configured to enable as an active profile a fallback profile in place of a previously-enabled profile upon detection of a loss of connectivity with a communication network of the IoT device.

2. The eUICC of claim 1, wherein the stored set of APIs comprises at least a first API configured to enable the fallback profile, a second API configured to disable the fallback profile, and a third API configured to check whether a currently-enabled profile for operation corresponds to the fallback profile.

3. The eUICC of claim 2, wherein the stored application is configured to check by the third API the currently-enabled profile and take an action to disable the fallback profile by the second API coming back to the previously-enabled profile, or enable the fallback profile by the first API depending on the currently-enabled profile corresponding to the fallback profile or the previously-enabled profile.

4. The eUICC of claim 2, wherein the stored application is configured to, following an enabling of the fallback profile by a remote manager module upon the detection of the loss of connectivity, check that the currently-enabled profile corresponds to the fallback profile, and switch back from the fallback profile, enabling the previously-enabled profile and disabling by the second API the fallback profile.

5. The eUICC of claim 4, wherein the stored application is configured to ignore action to enable and/or disable the fallback profile by the remote manager module.

6. The eUICC of claim 4, wherein the remote manager module is a first IoT Profile Assistant in the IoT device or a second IoT Profile Assistant in the eUICC.

7. The eUICC of claim 2, wherein the stored application is configured to, upon the detection of the loss of connectivity by the stored application, enable, through the first API, the fallback profile.

8. The eUICC of claim 1, wherein the subset of APIs is configured to operate through native modules in an operating system of the eUICC that manage profiles installed on the eUICC.

9. A method for managing an embedded Universal Integrated Circuit Card (eUICC) for an Internet of Things (IoT) device, the method comprising:
enabling a fallback profile in place of a previously-enabled profile upon detection of a loss of connectivity with a communication network of the IoT device;
managing, by an application stored in the eUICC, at least an enabling a fallback profile operation and a disabling the fallback profile operation; and
accessing, by the stored application, a set of stored application programming interfaces (APIs) of the eUICC comprising a subset of APIs configured to perform profile managing operations comprising at least the enabling and disabling the fallback profile operations.

10. The method according to claim 9, wherein the stored set of APIs comprises at least a first API configured to enable the fallback profile, a second API configured to disable the fallback profile, and a third API configured to check whether a currently-enabled profile for operation corresponds to the fallback profile.

11. The method according to claim 10, further comprising:
checking by the third API the currently-enabled profile and take an action to disable the fallback profile by the second API coming back to the previously-enabled profile, or enable the fallback Profile by the first API depending on the currently-enabled profile corresponding to the fallback profile or the previously-enabled profile.

12. The method according to claim 10, further comprising:
following an enabling of the fallback profile by a remote manager module upon the detection of the loss of connectivity, checking by the stored application that the currently-enabled profile corresponds to the fallback profile, and switching back from the fallback profile, enabling the previously-enabled profile and disabling by the second API the fallback profile.

13. The method according to claim 12, further comprising:
ignoring, by the stored application, action to enable and/or disable the fallback profile by the remote manager module.

14. The method of claim 12, wherein the remote manager module is a first IoT Profile Assistant in the IoT device or a second IoT Profile Assistant in the eUICC.

15. The method according to claim 10, further comprising:
upon detection of the loss of connectivity by the stored application, enabling by the stored application, through the first API, the fallback profile.

16. The method according to claim 9, wherein the eUICC for the IoT device is operated according to a GSMA SGP.32 standard.

17. An Internet of Things (IoT) device comprising:
an embedded Universal Integrated Circuit Card (eUICC) comprising:
a stored set of application programming interfaces (APIs) comprising a subset of APIs configured to perform profile managing operations comprising at least an enabling a fallback profile operation and a disabling the fallback profile operation; and
a stored application configured to access the stored set of APIs of the eUICC, in order to perform the enabling and disabling the fallback profile operations of the subset of APIs;
wherein the eUICC is configured to enable as an active profile a fallback profile in place of a previously-enabled profile upon detection of a loss of connectivity with a communication network of the IoT device; and
an IoT profile assistant (IPA) block configured to serve as a proxy between the eUICC and an embedded subscriber identity module IoT remote manager.

18. The IoT device according to claim 17, wherein the eUICC further comprises:
an issuer security domain–root block configured to interface with the IPA block through a first IPA—eUICC interface for performing profile download and installation operations and handling profile discovery, and a second IPA—eUICC interface for performing generic eUICC package download and execution; and
an issuer security domain–profile block comprising a mobile network operator security domain block configured to interface with a mobile network operator.

19. The IoT device of claim 18, wherein the stored set of APIs comprises at least a first API configured to enable the fallback profile, a second API configured to disable the fallback profile, and a third API configured to check whether a currently-enabled profile for operation corresponds to the fallback profile.

20. The IoT device of claim 19, wherein the stored application is configured to check by the third API the currently-enabled profile and take an action to disable the fallback profile by the second API coming back to the previously-enabled profile, or enable the fallback profile by the first API depending on the currently-enabled profile corresponding to the fallback profile or the previously-enabled profile.
